(19) United States
(12) Patent Application Publication
(10) Pub. No.: US 2022/0380232 A1
(43) Pub. Date: Dec. 1, 2022

(54) COLLECTION, FILTRATION, AND AGGREGATION OF EMULSIONS AND PARTICLES USING CYLINDERS

(71) Applicant: Northwestern University, Evanston, IL (US)

(72) Inventors: Kyoo-Chul Park, Evanston, IL (US); Christian John Machado, Evanston, IL (US); Youhua Jiang, Shantou (CN); Jonathan Switzer, Chicago, IL (US)

(21) Appl. No.: 17/772,248

(22) PCT Filed: Nov. 12, 2020
(86) PCT No.: PCT/US20/60210

§ 371 Date: Apr. 27, 2022

Related U.S. Application Data
(60) Provisional application No. 62/934,055, filed on Nov. 12, 2019.

(51) Int. Cl. C02F 1/40; C02F 1/00

(52) U.S. Cl. CPC C02F 1/40; C02F 1/001; C02F 2101/32

(57) ABSTRACT

Particle removal systems and methods are provided. The systems and methods utilize flexible wires to collect solid particles and remove them from a carrier liquid in which they are suspended. The solid particles, the wires, or both the solid particles and the wires are coated by a liquid. As the carrier liquid containing the particles passes through the particle removal system, the liquid coatings on the solid particles and/or the flexible wires selectively adhere the solid particles to the flexible wires.

### CROSS-REFERENCE TO RELATED APPLICATION

The present application claims the priority benefit of U.S. Provisional Patent App. No. 62/934,055 filed on Nov. 12, 2019, the entire disclosure of which is incorporated by reference herein.

### BACKGROUND

The separation and filtration of small solid particles, such as microplastic particles, from water or other liquids are fundamentally important to the environment conservation and various industrial applications. In particular, oceanic oil spills and the release of microplastics may significantly jeopardize marine life and human beings. Although there are many methods to remove spilled oil, methods of filtrating microplastic particles are rare.

Conventional water cleaning technologies utilize mesh filters to collect particles suspended in liquids, such as water. However, these systems are fundamentally limited because the filters get clogged due to aggregated particles, which results in short filter replacement cycles and added maintenance costs, in addition to the energy costs involved with running the system.

### SUMMARY

Methods for capturing liquid-coated solid particles suspended in a carrier liquid are provided.

One embodiment of a method for capturing solid particles encapsulated in a coating liquid and suspended in a carrier liquid uses a particle capture system that includes: a housing that includes a wall, wherein the wall has an interior surface and an exterior surface; and a plurality of layers of flexible wires, each flexible wire having a proximal end and a distal end, wherein the distal end is mounted to the interior surface of the wall and the proximal end is free. The method includes the steps of: flowing the carrier liquid over the flexible wires, wherein the coating liquid adheres to the flexible wires such that the solid particles become captured on the flexible wires, and further wherein the flexible wires bend along the direction of the carrier liquid flow such that the captured solid particles in the coating liquid move toward the proximal ends of the flexible wires and become aggregated in the coating liquid under the force of the carrier liquid flow; and collecting the aggregated solid particles and the coating liquid released from the proximal ends of the flexible wires.

One embodiment of a particle removal system includes: a wire filter and a receptacle. The wire filter includes: a housing that includes a wall, wherein the wall has an interior surface and an exterior surface; and a plurality of flexible wires mounted in the housing, each flexible wire having a proximal end, a distal end, and an external surface, wherein the distal end is mounted to the interior surface of the wall, the proximal end is free, and the external surface is coated with a liquid film. The receptacle is configured to receive particles released from the plurality of wires using precipitation, in the case of a higher density of the aggregated particles with the coating liquid, or buoyancy force, in the case of a lower density of the aggregated particles with the coating liquid.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1 (panels (a)-(g)) depicts the capture and release of solid particles by a wire when the carrier fluid flow direction is from left to right.

FIG. 2 depicts a liquid-borne particle removal system with flexible wires mounted in it in accordance with an illustrative embodiment.

FIG. 3A is a partial cross-sectional view of a wire filter that depicts a mounted wire bending under a force of a carrier liquid flow (direction of carrier liquid flow is top-to-bottom) in accordance with a first illustrative embodiment.

FIG. 3B is a partial cross-sectional view of a wire filter that depicts a mounted wire bending under a force of a carrier liquid flow (direction of carrier liquid flow is top-to-bottom) in accordance with a second illustrative embodiment.

FIG. 3C includes a partial view and a partial blown-up cross-sectional view of a wire filter in accordance with an illustrative embodiment.

FIG. 3D shows the capture and release of solid particles in a carrier fluid using the wire filter of FIG. 3C.

FIG. 4A is a cross-sectional view of a liquid-borne particle removal system with a plurality of liquid-borne particle collection wires in accordance with a first illustrative embodiment. In this embodiment, the collection wires take the form of cylindrical brush-like rods.

FIG. 4B is a cross-sectional view of a liquid-borne particle removal system with a plurality of liquid-borne particle collection tubes in accordance with a second illustrative embodiment.

FIG. 5 shows images of 4 cm long (top), 3 cm long (middle), and 2 cm long (bottom) polydimethysiloxane (PDMS) wires in a continuous flow of water.

FIG. 6 (panels (a)-(h)) shows time-lapse images of the capture of a microplastic particle by an oil-coated wire and its subsequent release in an oil droplet from the proximal end of the wire.

### DETAILED DESCRIPTION

Described herein are particle removal systems and methods for improving water quality that avoid the problem of rapidly clogging filters and the associated increased maintenance costs to replace them.

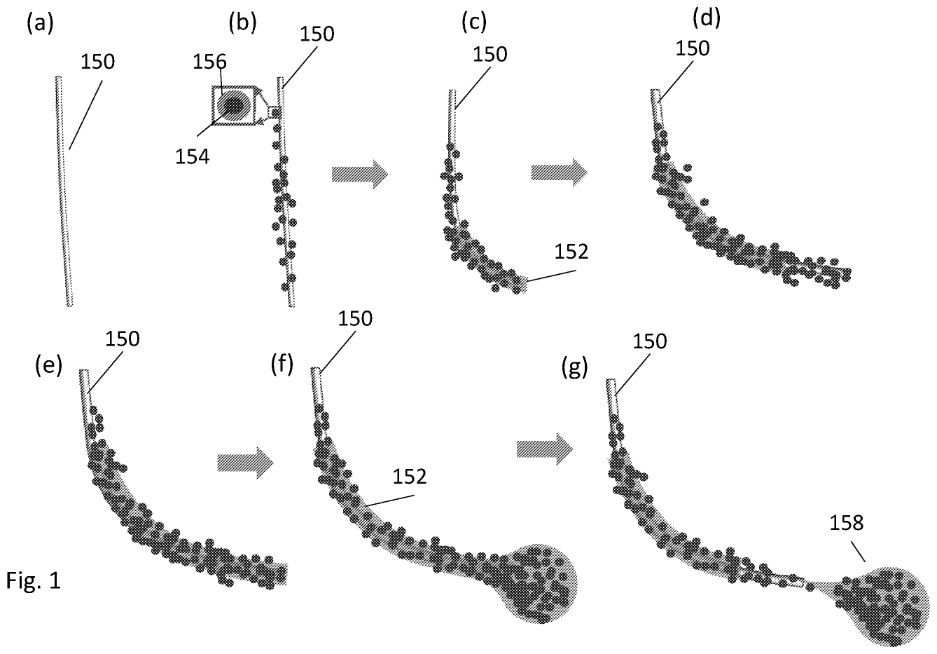

In an illustrative embodiment, the proposed system uses flexible wires to efficiently collect liquid-borne particles and remove them from the liquids in which they are dispersed. Many particles in the environment are encapsulated in a liquid coating. For example, microplastic particles in the ocean naturally become coated with oils, such as petroleum, other hydrophobic liquid pollutants, microbial biofilms, and/or other hydrophilic liquids. The liquids may be Newtonian or non-Newtonian. The systems and methods described herein take advantage of such coatings that encapsulate the liquid-borne particles and/or flexible wires; as a liquid containing encapsulated particles passes through the particle removal systems, the coating that encapsulates the solid particles selectively adheres to mechanically flexible wires in the particle removal systems. This process is illustrated schematically in FIG. 1, using a single flexible wire 150 (panel (a)).

As a liquid flows across a wire 150, dispersed solid particles 154 that are encapsulated in a liquid coating 156 become adhered to the wire 150 (FIG. 1, panel (b)). The adhered particles then become aggregated in a film 152 of liquid coating 156 and transported along the wire, which is deformed by liquid flow, such that the wire is gradually aligned along the direction of liquid flow (FIG. 1, panels (c)-(e)). Eventually, the captured particles agglomerated in coating liquid 158 reach the free ends of flexible wires and become detached from the wires due to the pinch off dynamics of liquid-encapsulated particles (FIG. 1, panels (f) and (g)). Because the detached particle aggregates are larger than individual particles and the difference between the density of the particle aggregates and the liquid in which they are dispersed is more pronounced, the captured particles are more easily separated from the liquid than are individual particles under the force of gravity. The particle capture can be carried out passively; no additional inputs, such as electricity, chemicals, or thermal energy control, are required.

The particle recovery systems can be used to filter out particles of various sizes, but they are particularly useful in filtering out small particles, including particles having a maximum cross-sectional dimension of 10 mm or less. Micro-scale particles having maximum cross-sectional dimensions of 100 μm or less can also be filtered. Thus, particles with maximum cross-sectional dimensions in the range from 0.1 μm to 10 mm can be filtered. However, particles with sizes outside of this size range can also be filtered. As used herein, the term particles can refer to any combination of chemical particles, biological particles, pathogens, germs, viruses, microfibers, microfilaments, emulsions, natural micro-scale particles such as pollen, water, etc. that are present in water and other liquids. In some embodiments of the methods, the filters are used to collect, filter, and/or aggregate plastic particles. Plastic particles include microplastic particles, which for the purposes of this disclosure, are defined as plastic particles having a largest cross-sectional dimension of 5 mm or less. In other embodiments of the methods, the filters are used to collect, filter, and/or aggregate biological cells. Thus, in addition to microplastics, particles that can be captured from a liquid sample include biological molecules and biological cells from aqueous biological fluids, such as blood or urine.

The bending of flexible wires facilitates the release of collected particles by liquid drag force acting on the particles and transport of collected particles using gravity so that clogging can be prevented. The coating (e.g., oil or biofilm) that encapsulates the particles and/or forms a sticky film along the wires also facilitates the transport of the particles along the wire. Similarly, vibration of the flexible wires in combination with liquid flow (e.g., natural tides, currents, turbulence, fluctuations, and/or disturbances) can also help to aggregate the particles as they are transported along the wire, making the particles easier to separate from the liquid when they are released from the wires.

The wires are formed from materials that are readily wet by the liquid coatings that encapsulate the solid particles, such that the adhesion strength between the coatings and the wires allows the encapsulated particles to be captured on the wires. Many natural particle coatings are hydrophobic (e.g., oils) and, therefore, in some embodiments of the particle capture systems, the wires comprise hydrophobic materials. Conversely, if the liquid coatings on the particles are hydrophilic (e.g., microbial films), the wires may comprise hydrophilic materials. For the purposes of this disclosure, a material is hydrophobic if it has a static water contact angle greater than 90° and hydrophilic if it has a static water contact angle of less than 90°, as measured using an optical tensiometer. Hydrophobic materials include superhydrophobic materials, which have a static water contact angle greater than 150°. As used herein, the term microbial biofilm refers to a liquid film comprising microorganisms, such as bacteria and/or algae. Typically, within a microbial biofilm, the microorganisms are embedded in a matrix of self-produced extracellular polymeric substances which form an encapsulating viscous liquid.

The liquid coating encapsulating the particles may be sufficient to form a liquid coating on the surfaces of the wires as the particles are captured. For example, over time the microbial biofilm covering microplastic particles can form a liquid microbial biofilm on the wires, and this liquid microbial biofilm can facilitate continued particle capture and aggregation. However, the wires may be pre-coated with a liquid coating (liquid film) in order to facilitate particle capture from the outset. The liquid pre-coating should be selected to provide adhesion between the liquid encapsulating the particles and the wires. The liquid used to pre-coat the wires may be the same as, or different from, the liquid that encapsulates the particles. In some embodiments, the liquid used as the pre-coating is a microbial biofilm, an oil or other Newtonian fluid, or a non-Newtonian fluid. It should be noted that when the wires are pre-coated with a liquid film, the solid particles need not be encapsulated with a liquid coating in order to be captured and collected by the systems and methods described herein.

The systems described herein can be used to collect liquid-borne (e.g., water-borne) particles from natural bodies of water, such as oceans, lakes, and rivers, and from commercial, municipal, and/or residential wastewater. For example, the water filtration systems can be used to purify drinking water, water for industrial purposes, water for home appliances, water discharged from home appliances, houses, buildings, factories, and the like. Commercial wastewater includes wastewater generated by chemical processing plants, pharmaceutical plants, fuel processing/distillation towers, and food production facilities. The methods can be used by chemical plant design/construction companies, wastewater treatment companies, desalination companies, factories, oil companies, personal protection equipment companies, and environmental protection companies.

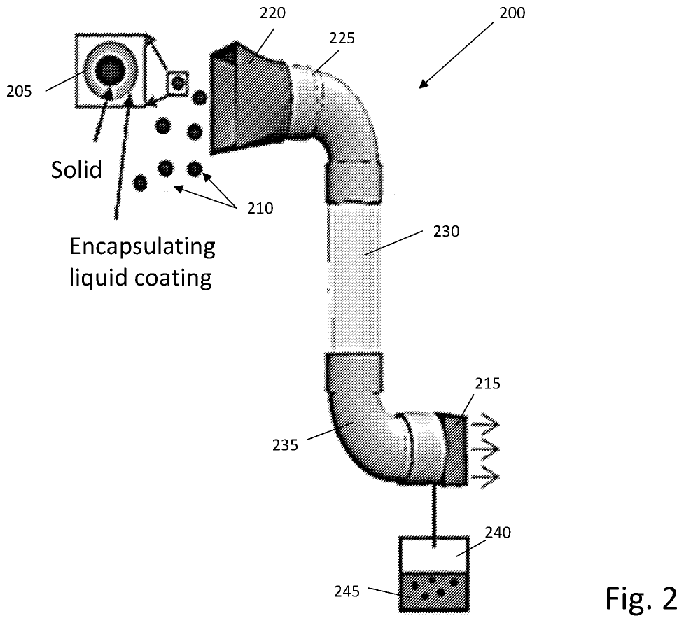

FIG. 2 depicts one embodiment of a liquid-borne particle removal system 200. The system of FIG. 2 includes a pump 215 that is used to draw a liquid through the particle removal system 200. The liquid carries solid particles that are encapsulated in a liquid coating. For purposes of clarity, the liquid that carries the solid particles is referred to as a carrier liquid, while the liquid that encapsulates the particles is referred to as a coating liquid. The coating liquid differs from, and is immiscible with, the carrier liquid. In some applications, the pump 215 may be omitted from the system. The liquid-borne particle removal system 200 includes an inlet port 220 that receives a carrier liquid (e.g., seawater 210), a first elbow 225 mounted to the inlet port 220 and a proximal end of a wire filter 230, a second elbow 235 mounted to a distal end of the wire filter 230 and the pump 215, and a receptacle 240 to collect the aggregated particles and their encapsulating liquid coating which are removed from the carrier liquid by the gravitational force, buoyancy force, or any force that would differentiate the aggregated particles from the carrier liquid. As used herein, ‘proximal’ refers to the direction towards the inlet port end of the particle removal system 200, and ‘distal’ refers to the direction towards the receptacle 240 of the particle removal system 200. Optionally, the collected solid particles can be separated from the collected coating liquid.

In an illustrative embodiment, the inlet port 220 has a tapered shape in which a circumference of a proximal end of the inlet port 220 is larger than a circumference of a distal end of the inlet port 220. Alternatively, the circumference of the proximal end can be the same as the circumference of the distal end of the inlet port 220. In some embodiments, the proximal end of the inlet port 220 can have a profile of a first shape (e.g., a square, rectangle, circle, oval, triangle, etc.), and the distal end of the inlet port 220 can have a profile of a second shape (e.g., a square, rectangle, circle, oval, triangle, etc.). In alternative embodiments, the profiles of the proximal and distal ends of the inlet port 220 can have the same shape and/or size. In some embodiments, the proximal and distal ends of the inlet port 220 can have the same shape, but different sizes. In the embodiment of FIG. 2, the distal end of the inlet port 220 has a profile that is circular in shape such that the distal end of the inlet port 220 mates with and mounts to a proximal end of the first elbow 225.

The inlet port 220 directs the carrier liquid to be cleaned into the first elbow 225. A distal end of the first elbow 225 mates with and mounts to a proximal end of the wire filter 230. As shown, the first elbow 225 transitions the carrier liquid flow from horizontal (i.e., substantially parallel to a ground/floor surface) to vertical (i.e., substantially perpendicular to the ground/floor surface). As discussed in more detail below, this configuration allows gravity to act upon aggregated particles such that they collect in the receptacle 240. In the orientation of the embodiment of FIG. 2, the carrier liquid flows in a vertical downward direction through the wire filter 230 at an angle of approximately 90° relative to the ground/floor surface. In alternative implementations, the carrier liquid can flow in a vertical upward direction through the wire filter 230. Additionally, regardless of whether carrier liquid flows in an upward or downward direction, the orientation of the wire filter 230 can be at any angle between 0-360° relative to the ground/floor surface. In some embodiments, there are multiple wire filter 230 in different orientations connected by multiple 10-350° elbows. In some embodiments, the wire filter 230 are spiral, coil-shaped, twist-shaped, or serpentine-shaped.

The wire filter 230 includes a housing and a plurality of layers of wires mounted within the housing. The housing can be formed from, for example, a plastic, metal, rubber, ceramic, or other material. The plurality of layers of wires are designed to collect solid particles entrained within the carrier liquid as the carrier liquid passes through the wire filter 230. Each of the wires is mounted to an interior surface of the housing of the wire filter 230. Optionally, the wires may be pre-coated with a liquid coating, such as an oil or a biofilm, including captured oil from the water intake and naturally grown biofilms as discussed above. The wires can be mounted to the housing using a weld, solder, adhesive, clip, fastener, etc. In some embodiments, the wires are detachable from the housing such that they can be replaced. In such an embodiment, the wires can attach to the housing via a removable fastener, a friction fit male/female connection (e.g., peg and hole, loop and hook, etc.), a magnetic connection, etc. The wires are described in more detail in FIG. 2. As shown in FIG. 2, the wire filter 230 is a hollow tube with a cylindrical shape (circular cross-section). In alternative embodiments, the wire filter 230 can have a different shape and/or cross-section (e.g., square, rectangle, triangle, oval, irregular, etc.). In another alternative embodiment, in addition to the wire filter 230, the inlet port 220, the first elbow 225, and/or the second elbow 235 can include layers of wires mounted to the interior surfaces thereof and designed to collect particles from the carrier liquid.

A distal end of the wire filter 230 mates with and mounts to a proximal end of the second elbow 235. In an illustrative embodiment, gravity and/or liquid flow causes collected particles 245 to move from the wire filter 230 into the second elbow 235, from which they are directed into the receptacle 240. The pump 215 is mounted at the distal end of the second elbow 235. In alternative embodiments, pump 215 may not be used. In such implementations, tides, currents, and other natural phenomena can be used to direct carrier liquid into and through the system. In alternative embodiments, the inlet port 220, the first elbow 225, the second elbow 235, and/or the pump 215 may not be included in the particle removal system 200. In such embodiments, a proximal end of the wire filter can act as the inlet port and the distal end of the wire filter can be directly or indirectly mounted to the receptacle such that collected particles are deposited therein. In other embodiments, the receptacle 240 may not be included.

In an illustrative embodiment, the receptacle 240 can be an enclosed container (i.e., not exposed to the environment) that is designed to store accumulated collected particles. The receptacle 240 can be mounted directly or indirectly (i.e., using a duct or other conduit) to the distal end of the second elbow 235 in some embodiments. In one embodiment, the receptacle 240 can include an access panel (e.g., a hinged door, removable panel, plugged hole, drain, etc.) that allows collected particles to be removed therefrom. Alternatively, the receptacle 240 may include a port connected to a vacuum hose that is used to vacuum the collected particles out of the receptacle 240 such that it does not exceed its collection capacity.

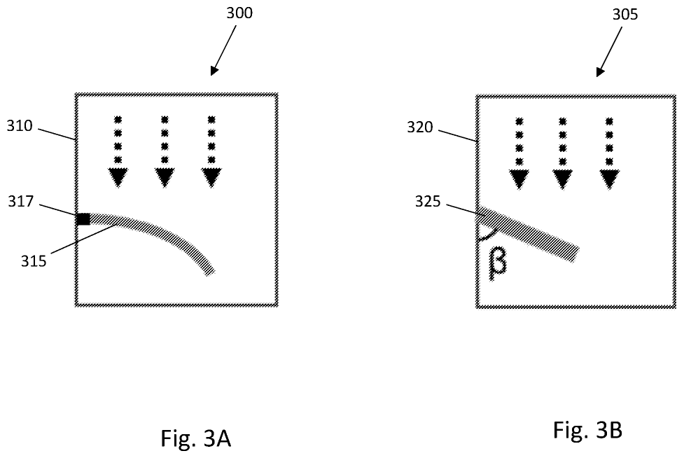

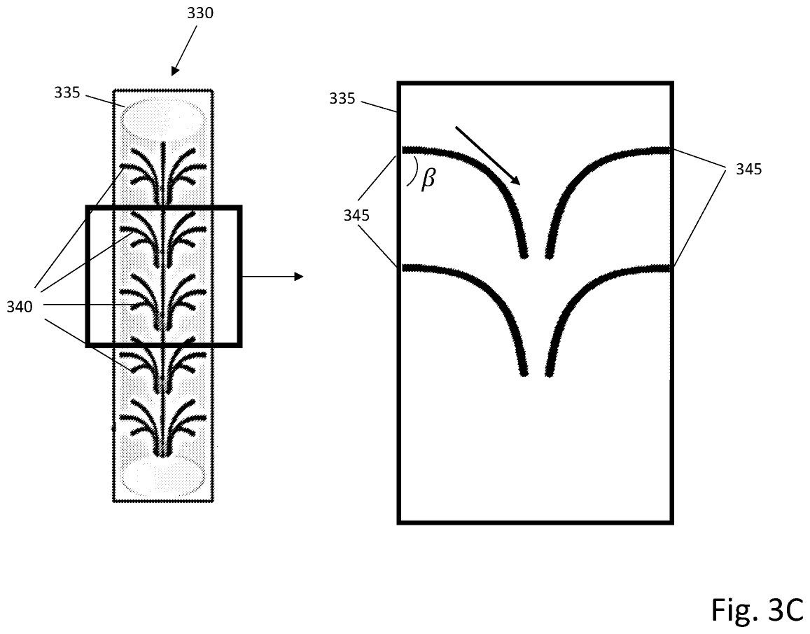

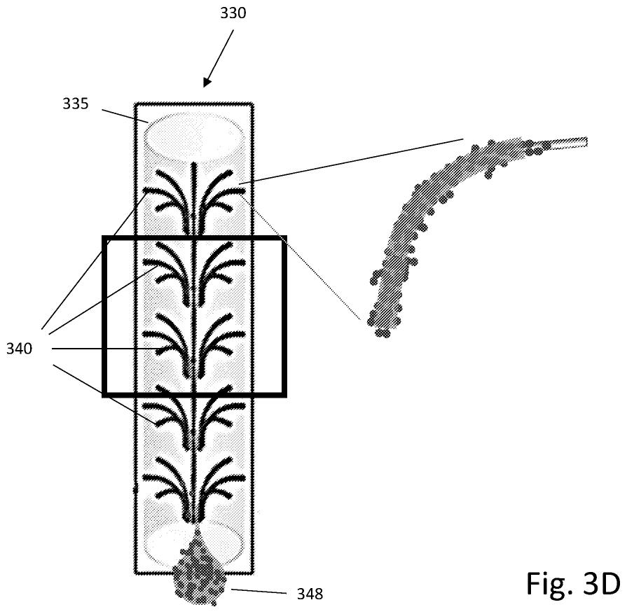

FIG. 3A is a partial cross-sectional view of a wire filter 300 that depicts a mounted wire in accordance with a first illustrative embodiment. FIG. 3B is a partial cross-sectional view of a wire filter 305 that depicts a mounted wire in accordance with a second illustrative embodiment. FIG. 3C includes a partial cross-sectional view and a blown-up cross-sectional view of a wire filter in accordance with an illustrative embodiment. In FIGS. 3A and 3B, the arrows with dashed lines depict the direction of liquid flow through the system.

The wire filter 300 of FIG. 3A includes a housing 310, and a wire 315 is mounted to an interior side of a wall of the housing 310. The wire 315 is curved such that a distal end of the wire 315 (i.e., the end not mounted to the wall of the housing 310) has a lower elevation than a proximal end (i.e., the end mounted to the wall of the housing 310) of the wire 315. The curve in the wire 315 facilitates the movement of collected particles along the wire 315 in a direction that travels from the proximal end toward the distal end of the wire 315, maintaining the particles in contact on the wire due to the encapsulating coating liquid between the wire and solid particles. As discussed herein, the wire 315 can be flexible and a curve in the wire 315 can be due to gravity and liquid flow as particles accumulate thereon. Alternatively, the wire 315 may be rigid and formed into the curved shape. As a result, the collected particles accumulate at the end of the wire 315 until their combined mass releases from the end and moves toward the receptacle of the system.

In an illustrative embodiment, all of the wire 315 or at least a portion of the wire 315 can be flexible such that the curvature of the wire 315 changes as particles accumulate thereon. For example, the wire 315 can be made of a semi-flexible material such as a metal, rubber, plastic, polymeric, etc. In some embodiments, only a portion of the wire 315 is flexible. For example, a distal ½ (or ⅓, ¼, ⅕, etc.) of the wire 315 may be flexible and the remainder may be rigid. In another alternative embodiment, the wire 315 may be rigid (in either a curved or straight configuration) and adjustable such that a user can remotely or directly adjust an angle of the wire 315 relative to the wall of the housing 310 using different methods including electromagnetic forces. The wire 315 can have a circular cross-sectional profile in one embodiment. Alternatively, the cross-sectional profile of the wire 315 can be an inverted V, a square, a rectangle, a triangle, an oval, etc.

The wire 315 can be mounted to the housing 310 using a weld, solder, adhesive, clip, fastener, hinge, friction fit (e.g., a cup mounted to the wall and designed to receive the wire 315), etc. The wire 315 can be permanently or detachably mounted to the housing 310 depending on the implementation. In one embodiment, an actuator or manual control can be used to adjust an angle of the wire 315. For example, an actuator 317 can be optionally mounted to the wire 315 such that movement of the actuator 317 moves the angle of the wire 315 relative to the wall of the housing 310. The actuator 317 can also be used to vibrate or shake the wire 315 to facilitate more rapid release of the collected particles from the wire 315. The actuator 317 can be remotely controlled through a wired or wireless connection. In the case of wireless control, the actuator 317 can include a transceiver to receive the control signal from the remote location. The actuator 317 can also include a power source (e.g., battery), processor, memory, and/or other components to control movement of the wire 315. In an alternative embodiment, an actuator can be used to move the entire system such that some or all of the wires within the wire filter are moved/vibrated simultaneously.

Alternatively, the wire 315 may be manually adjustable. For example, an extension can extend through the wall of the housing 310 such that a user can manipulate the angle of the wire 315 relative to the wall of the housing 310 by manipulating the extension. The extension can be a portion of the wire, or a lever, handle, or other control mounted to the proximal end of the wire 315. In such an embodiment, the wire 315 can be mounted to the wall of the housing 310 such that the wire 315 pivots relative to the wall. As such, moving the extension in a downward direction would cause the distal end of the wire 315 to rise in elevation, and moving the extension in an upward direction would cause the distal end of the wire 315 to drop in elevation (assuming the wire filter 305 is mounted vertically as depicted).

The wire filter 305 of FIG. 3B includes a housing 320 and a wire 325 mounted to an interior side of a wall of the housing 320. The wire 325 is straight and mounted at an angle β such that a distal end of the wire 325 (i.e., the end not mounted to the wall of the housing 320) has a lower elevation than a proximal end (i.e., the end mounted to the wall of the housing 320) of the wire 325. The angle at which the wire 325 is mounted facilitates the movement of collected particles along the wire 325 in a direction that travels from the proximal end toward the distal end of the wire 325. As a result, the collected particles accumulate at the end of the wire 325 until their combined mass releases from the end and moves toward the receptacle of the system. In an illustrative embodiment, the angle β can be any angle between 0-90°.

In some embodiments, at least a portion of the wire 325 can be flexible such that the wire 325 changes from straight to curved as liquid-borne particles are collected thereon. For example, the wire 325 can be made of a semi-flexible material such as a metal (e.g., aluminum), rubber, plastic (e.g., polydimethysiloxane; PDMS), etc. The amount of wire bending becomes more significant at higher liquid flow speeds and smaller elastic modulus, and the extent of bending of the wire corresponds to the wire geometry and elastic modulus at the specific liquid flow speed. In some illustrative embodiments, the wires have an elastic modulus of at least 0.01 MPa, 0.1 MPa, 1 MPa, at least 2 MPa, or at least 5 MPa.

Suitable methods of fabricating wires include those typically used in the manufacturing of flexible fibers, for example, fibers for tooth brushes or artificial grass. By way of illustration, injection molding of polymer wires, 3D printing or extrusion, or simply razor cutting of a polymer sheet into strips (wires) are methods that can be used. If the wires are formed from a curable polymer, such as PDMS, the degree of cure (i.e., cross-linking) and composition of the base liquid and curing agent can be tailored to systematically change the stiffness (i.e., Young's modulus) of the wires. The stiffness of the wire can be gradient or discontinuous from the proximal end to the distal end of the wire.

In some embodiments, only a portion of the wire 325 is flexible. For example, a distal ½ (or ⅓, ¼, ⅕, etc.) of the wire 325 may be flexible and the remainder may be rigid. In one embodiment, the wire 325 may be adjustable such that a user can remotely or directly adjust an angle of the wire 325 relative to the wall of the housing 320. Suitable angles include angles in the range from 5° to 85°. The angle of the wire 325 can be adjusted using any of the techniques described herein. Similarly, the wire 325 can be mounted to the housing 310 using any of the techniques described herein.

The left portion of FIG. 3C shows a wire filter 330 in accordance with an illustrative embodiment. As shown, the wire filter 330 includes a housing 335 and S layers 340 of wires mounted to the interior wall of the housing 335. Alternatively, a different number of layers may be used such as 1, 2, 3, 10, 25, 50, 100, 1000, etc. Additionally, each of the layers can include 1, 2, 3, 5, 10, 25, 50, 100, etc. wires. In one embodiment, the wires in each layer can be mounted at an equal distance apart from one another in a circle within the housing 335 (i.e., such that a line connecting the mounting locations of the wires on the housing is a circle). Alternatively, the wires of each layer can be mounted offset from one another (e.g., such that a series of lines connecting the mounting locations of the wires on the housing 335 form a sawtooth wave). Alternatively, the wires can be positioned randomly or in a pattern about the interior wall of the housing 335. For example, one pattern can position all of the wires in the housing 335 such that they are equidistant from one another. Other patterns can include a single, double, triple helical array of wires on the housing 335. In the embodiment of the FIG. 3C, the housing 335 is transparent. In alternative embodiments, the housing 335 may be opaque or translucent.

The dimensions of the wires should allow them to be flexible and provide sufficient surface area to achieve the desired degree of particle removal. The lengths and diameters of the wires are not particularly limited; lengths of several micrometers to several centimeters (e.g., 1 micron to 500 cm) and diameters of several tenths of micrometers to several millimeters (e.g., 0.1 microns to 10 mm) may be used. By way of illustration only, in some embodiments of the systems, the wires have diameters of 5 cm or less, 1 cm or less, 5 mm or less, 1 mm or less, 0.5 mm or less, 0.1 mm or less, 0.05 mm or less, or 0.01 mm or less. For example, the wires may have diameters in the range from 0.1 microns to 5 cm. By way of further illustration, in some embodiments of the systems, the wires have lengths of 10 cm or less, 1 cm or less, 5 mm or less, 1 mm or less, 0.5 mm or less, 0.1 mm or less, 0.05 mm or less, or 0.01 mm or less. By way of further illustration, in some embodiments of the systems, the wires have lengths of 10 cm or greater, 1 m or greater, 10 m or greater, or 100 m or greater, including, for example, lengths in the range from 10 m to 1000 m. The diameter (width) of the housing should be sized to fit the wires.

The right portion of FIG. 3C depicts a close-up view of wires 345 mounted to the housing 335 at an angle β relative to the wall of the housing 335. In an illustrative embodiment, the distal tips of the wires 345 do not contact one another within the interior of the housing 335. However, in some alternative embodiments, the distal tips of the wires 345 may be in partial contact with one another such that an opening is formed at each layer through which the collected particles travel as they release from the distal ends of the wires 345 due to liquid forces, gravity, coating(s) on the wires 345, vibration or other movement of the wires 345, etc. The arrow in FIG. 3C depicts a direction of flow of collected particles.

A computing system may be used to perform any of the operations described herein to generate a design for an optimal wire filter based on filter size, liquid flow speed, application, etc. The computing system can include a processor, memory, user interface, and transceiver. The memory can store the operations described herein as computer-readable instructions. The processor can access the computer-readable instructions from the memory and execute them to perform the operations such that a wire filter design is generated. Data and preferences can be input through the user interface by a user, and the transceiver is used for communication with other local and remote computing systems.

FIG. 3D shows the particle removal system of FIG. 3C, with an enlarged view of a wire having particles captured thereon and aggregated particles in a coating liquid 348 being released from the fibers.

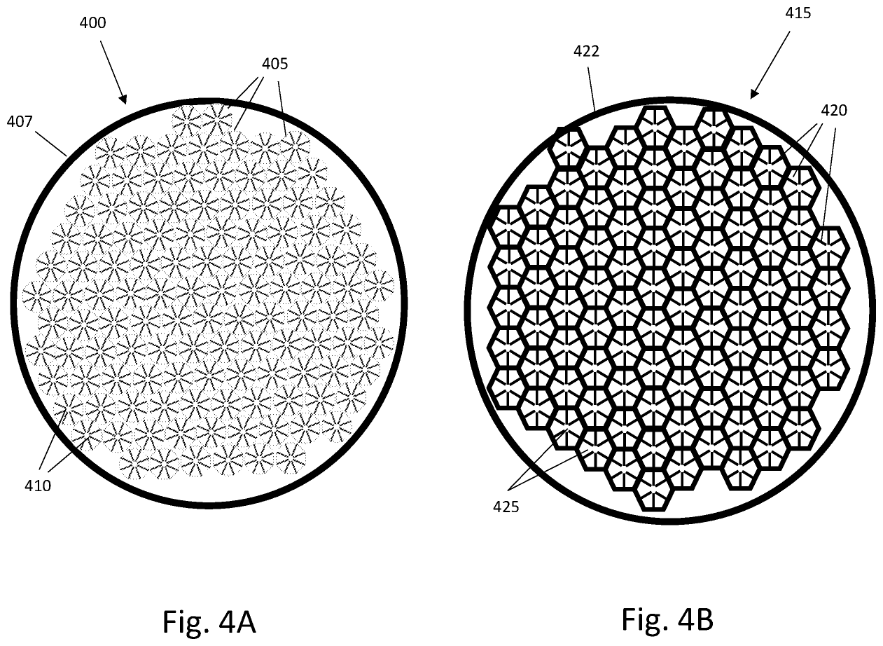

In one embodiment, the particle removal system includes a plurality of the hollow tubes (or individual housings) that are formed within a main housing. Each of the plurality of tubes includes a plurality of layers of wires that are used to collect particles from a carrier liquid that passes through the main housing. FIG. 4A is a cross-sectional view of a particle removal system 400 with a plurality of particle collection tubes 405 in accordance with a first illustrative embodiment. As shown, the particle collection tubes 405 are circular in shape and are positioned within a main housing 407. Each of the tubes 405 includes a plurality of layers of wires 410 (only one layer is visible in each tube in the view of FIG. 4A). FIG. 4B is a plan view of a liquid-borne particle removal system 415 with a plurality of liquid-borne particle collection tubes 420 in accordance with a second illustrative embodiment. As shown, the particle collection tubes 420 are hexagonal in shape to form a honeycomb pattern, and are positioned within a main housing 422. Each of the tubes 420 includes a plurality of layers of wires 425 (only one layer is visible in each tube in the view of FIG. 4B). In alternative embodiments, different shapes may be used for the individual tubes and/or the main housing, such as square, rectangular, triangular, etc. In other alternative embodiments, the main housing may not be included, and the system can be formed via interconnection of the individual tubes (e.g., via a weld, adhesive, integrals structure, etc.). The individual tubes and wires of FIGS. 4A and 4B can include any of the features described herein (e.g., the wires can be flexible, coated, mounted at an angle, etc.), and can operate in accordance with the principles described herein. In other alternative embodiments, wires are attached to the outside of a small diameter tube or cylinder like a bottle brush and the assembled structures are placed in a main housing 407.

Although the embodiments described herein have referenced filtration of solid particles from water, it is to be understood that the proposed methods and systems are not so limited. The proposed methods and systems can similarly be used to remove particles from other types of liquids, including particles dispersed in aqueous and non-aqueous solutions. For example, the systems and methods can be used to remove liquid- or vapor-encapsulated solid particles, nano- to micro- to milli-droplets, or nano- to micro- to milli-bubbles, from acids, bases, hydrocarbons, fluorocarbons, and the like.

### Example

This example illustrates the operational principles of the liquid-borne particle filters.

Wire Bending Under the Force of Liquid Flow.

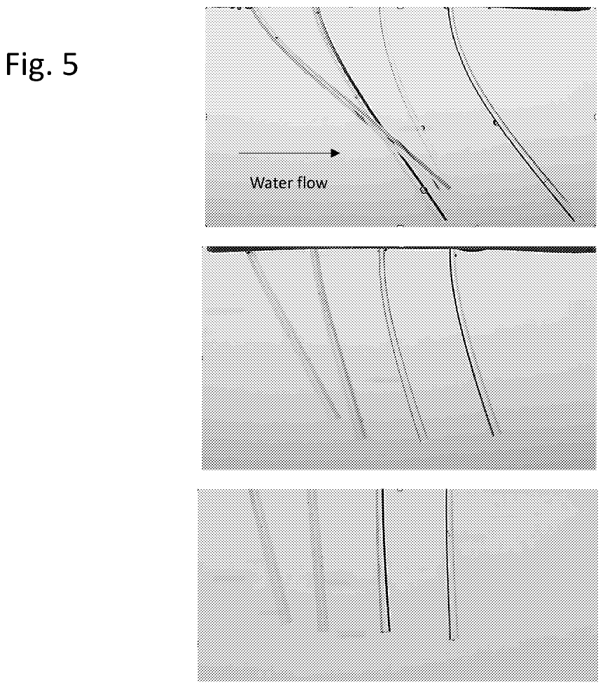

PDMS wires with diameters of 1 mm and lengths of 4 cm, 3 cm, and 2 cm were fixed in a row and water was flowed across the wires at a continuous flow speed of 20 cm/sec. FIG. 5 shows images of the 4 cm long (top), 3 cm long (middle), and 2 cm long (bottom) wires. It can be seen from the images that the deformation of wires having the same stiffness (i.e., Young's modulus) can be adjusted by changing the aspect ratio of the flexible wires. In addition, it can be seen that wire deformation is affected by the order of the wire in the array, with upstream wires undergoing a higher degree of deformation.

Particle Capture and Release.

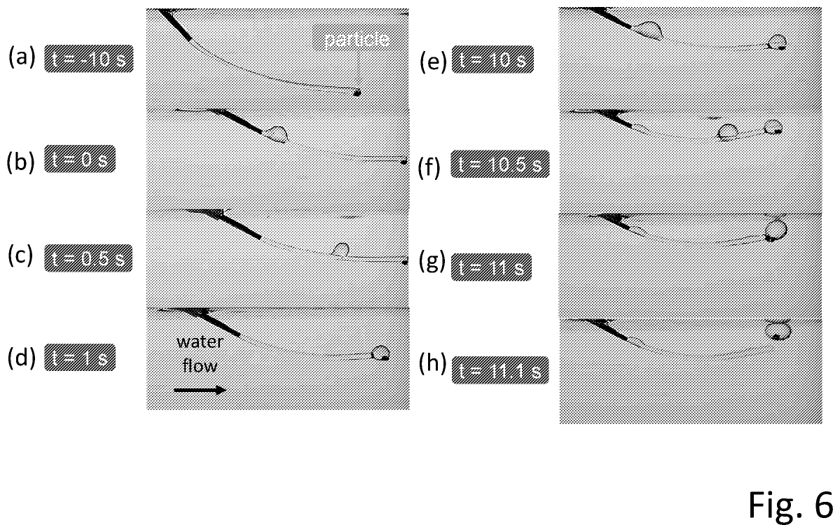

FIG. 6 shows time-lapse images of the capture of a microplastic particle by an oil-coated wire and its subsequent release in an oil droplet from the proximal end of the wire. A microplastic particle held by a tweezer was released into water flowing over a mineral oil-coated PDMS wire at a continuous flow rate of 20 cm/sec. The particle traveled to the free end of the oil-coated wire (FIG. 6, panel (a)). An oil droplet formed at the distal (fixed) end of the wire and traveled along the length of the wire until it encapsulated the microplastic particle (FIG. 6, panels (b)-(d)). A second oil droplet formed at the fixed end of the wire, then traveled along the length of the wire and coalesced with the first oil droplet (FIG. 6, panels (e)-(g)). Finally, the oil and the particle suspended therein were released from the free end of the wire (FIG. 6, panel (h)).

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A method for capturing solid particles encapsulated in a coating liquid and suspended in a carrier liquid using a particle capture system comprising:
a housing that includes a wall, wherein the wall has an interior surface and an exterior surface; and
a plurality of flexible wires, each flexible wire having a proximal end and a distal end, wherein the distal end is mounted to the interior surface of the wall and the proximal end is free, the method comprising:
flowing the carrier liquid across the flexible wires, wherein the coating liquid adheres to the flexible wires such that the solid particles become captured on the flexible wires, and further wherein the flexible wires bend along the direction of the carrier liquid flow such that the captured solid particles move toward the proximal ends of the flexible wires and become aggregated in the coating liquid under the force of the carrier liquid flow; and
collecting the aggregated solid particles and the coating liquid released from the proximal ends of the flexible wires.

2. The method of claim 1, further comprising separating the collected solid particles from the collected coating liquid.

3. The method of claim 1, wherein the carrier liquid is water.

4. The method of claim 1, wherein the solid particles are microplastic particles.

5. The method of claim 4, wherein the coating liquid comprises an oil.

6. The method of claim 4, wherein the coating liquid comprises a microbial biofilm.

7. The method of claim 4, wherein the carrier liquid is water from a natural body of water.

8. The method of claim 4, wherein, prior to flowing the carrier liquid across the flexible wires, the flexible wires are coated with a liquid film.

9. The method of claim 8, wherein the liquid film comprises an oil.

10. The method of claim 8, wherein the liquid film is a microbial biofilm.

11. The method of claim 8, wherein the liquid film comprises a non-Newtonian fluid.

12. The method of claim 1, wherein, prior to flowing the carrier liquid across the flexible wires, the flexible wires are coated with a liquid film.

13. The method of claim 12, wherein the liquid film comprises an oil.

14. The method of claim 12, wherein the liquid film is a microbial biofilm.

15. The method of claim 12 wherein the liquid film comprises a non-Newtonian fluid.

16. The method of claim 1, wherein the carrier liquid is urine or blood.

17. The method of claim 1, wherein the flexible wires have external surfaces and the external surfaces are hydrophobic.

18. The method of claim 1, wherein the flexible wires have external surfaces and the external surfaces are hydrophilic.

19. A method for capturing solid particles suspended in a carrier liquid using a particle capture system comprising:
a housing that includes a wall, wherein the wall has an interior surface and an exterior surface; and
a plurality of flexible wires mounted in the housing, each flexible wire having a proximal end, a distal end, and an external surface, wherein the distal end is mounted to the interior surface of the wall, the proximal end is free, and the external surface is coated with a liquid film, the method comprising:
flowing the carrier liquid across the flexible wires, wherein the solid particles adhere to the liquid film on the flexible wires such that the solid particles become captured on the flexible wires, and further wherein the flexible wires bend along the direction of the carrier liquid flow such that the captured solid particles move toward the proximal ends of the flexible wires and become aggregated in the liquid film under the force of the carrier liquid flow; and
collecting the aggregated solid particles and the liquid film released from the proximal ends of the flexible wires.

20. A liquid-borne particle removal system comprising:
a wire filter that includes:
a housing that includes a wall, wherein the wall has an interior surface and an exterior surface; and
a plurality of flexible wires mounted in the housing, each flexible wire having a proximal end, a distal end, and an external surface, wherein the distal end is mounted to the interior surface of the wall, the proximal end is free, and the external surface is coated with a liquid film; and
a receptacle configured to receive particles released from the plurality of wires.

21. The system of claim 20, further comprising a pump configured to draw a liquid through the housing.

22. The system of claim 20, wherein the liquid film comprises an oil.

23. The system of claim 20, wherein the liquid film is a microbial biofilm.

24. The system of claim 20, wherein the liquid film comprises a non-Newtonian fluid.
